(19) United States
(12) Patent Application Publication
(10) Pub. No.: US 2010/0294676 A1
(43) Pub. Date: Nov. 25, 2010

(54) SYNTHETIC MORTAR COMPOSITION

(76) Inventors: Jürgen Grün, Botzingen (DE); Markus Semmler, Emmendingen (DE); Christian Schlenk, Denzlingen (DE); Martin Vogel, Glottertal (DE)

Correspondence Address: MICHAEL J. STRIKER, 103 EAST NECK ROAD, HUNTINGTON, NY, 11743, US

(21) Appl. No.: 12/445,621

(22) PCT Filed: Sep. 20, 2007
(86) PCT No.: PCT/EP07/08180

§ 371 Date: Apr. 15, 2009

(30) Foreign Application Priority Data
Nov. 18, 2006 (DE) 10 2006 054 471.4

(51) Int. Cl. B65D 71/00; C08K 3/00

(52) U.S. Cl. 206/223; 524/4; 524/5

(57) ABSTRACT

A multi-component synthetic resin system, its use for securing fixing elements and a method for its preparation, and further embodiments mentioned in the description based on this invention, the multi-component synthetic resin system including one or more finely distributed gases in at least one of its components. Application is primarily in the construction industry.

The invention relates to multi-component synthetic resin systems, the use thereof to secure fixing elements and methods for the preparation thereof, and further embodiments of the invention mentioned further below.

It is known to use multi-component synthetic mortars, such as epoxy or polyurethane synthetic resin systems or radically curing synthetic resin systems or the like as fixing compositions in the construction industry, in particular as adhesives for anchoring elements.

As easy as it is to handle such multi-component synthetic mortars in practice—for example when used in the form of multi-chamber cartridges with static mixer, multi-chamber cartridges or pouches or other multi-chamber systems—further simplifications would nevertheless be desirable, perhaps a much improved flowability during discharge to reduce the extrusion force and the pressure required in preparation for filling the containers, reduced amounts of material and the like. In particular, the high force often required to extrude the mortar can cause fatigue in the user and may prejudice the acceptance of such systems. To lower the price of such systems, and also to improve the shrinkage properties, it is customary to provide a large proportion of fillers, but at the cost that the force required to extrude the mortar, for example, from cartridges, increases, and the stability (creep resistance, run resistance and drip resistance) declines on account of the increasing density and the consequently stronger effect of gravity. The latter can be very disadvantageous, in particular when the systems are used in cavity bricks in conjunction with mesh sleeves. Also, as a supplementary or alternative measure, thickening agents may be used—stability does then increase, but is again accompanied by the drawback that extrudability suffers. There is therefore always a conflict, between extrudability on the one hand and stability on the other.

It is therefore the aim of the invention to make available novel multi-component synthetic resin systems that have improved properties, especially in respect of the properties mentioned in the preceding paragraph, primarily in the direction of lower density, lower extrusion force required and/or improved stability, and to find ways of improving such properties.

Normally, air is removed virtually completely from the compositions of known such synthetic resin systems at the latest before final packaging, since above all gas bubbles, even macroscopic gas bubbles, for example, in the form of air bubbles, are regarded as troublesome and may lead to segregation or other inhomogeneities.

It has now unexpectedly been found that the presence of gases or gas mixtures, such as air, in particular in finely distributed, preferably atomic, molecular and/or finely dispersed (e.g. micro-dispersed) form, in such fixing compositions can not only be tolerated, but at the same time may even lead to improvements in respect of stability and/or extrudability, so that improved manageability can be achieved. The above-mentioned conflicts can thus be unexpectedly resolved: stability and extrudability can now be increased at the same time. Other important mechanical properties, such as the tensile strength and the pull-out force of anchoring elements from holes in a substrate are not affected, or not relevantly affected. One positive effect is that the corresponding synthetic resin systems also weigh less for the same volume (lower density) and thus less material input is required to achieve a good fixing action. Amazingly, the synthetic resin systems according to the invention also have excellent storage properties, with no segregation phenomena, such a bubble formation or partial or complete separation of gaseous and other components occurring.

Shelf life can be further improved by the addition of foam stabilisers.

The invention thus relates to a multi-component system mentioned initially, in which at least one component includes one or more (preferably atomically, molecularly and/or micro-dispersely distributed) finely distributed gases, in particular air.

The distribution of the gas or gases can advantageously be stabilised by the addition of foam stabilisers (for example silicon-containing or (in particular in certain industries where this is desired) silicon-free foam stabilisers).

In a further embodiment, the invention relates to the use of a multi-component synthetic resin system for fixing one or more fixing elements in a substrate, wherein use is made of a multi-component synthetic resin system that includes one or more finely distributed (preferably atomically, molecularly and/or micro-dispersely distributed) gases, in particular air, in at least one of its components, preferably in all components (e.g. in the case of a two-component system, in both components).

The invention also relates to a method for the preparation of a multi-component synthetic resin system, in particular for use for securing fixing elements, characterised in that one or more gases, such as air, are finely distributed, especially dissolved and/or dispersed, in at least one of the components of the synthetic resin system.

The general terms used above and/or hereafter are preferably as defined hereafter; within the present disclosure, inclusive of the claims, more general terms can be substituted independently of one another (individually, severally or collectively) by the more specific definitions, which produces in each case preferred embodiments of the invention:

A multi-component synthetic resin system shall be understood to mean a reactive resin system that includes two or more components, which after being mixed lead to a polyreaction and thus, by hardening, form a solid plastics composition. For example, the components may be a synthetic mortar (component (a)) and a hardener (component (b)). In addition to the ingredients leading to the polyreaction, other ingredients leading to hardening, for example, mineral materials hardenable from solutions or by hydration, such as cement, gypsum in the form of anhydride or hemihydrate, magnesia binders, phosphate binders, quicklime, water glass or silicate concrete, may also be provided in one or more of the components and/or separate components and contribute to hardening. These can be present in a proportion from 0 (especially 0.1) to 80, for example, from 1 to 50, % by weight.

As examples of such multi-component synthetic resin systems, mention may be made particularly of those based on synthetic mortars and one or more complementary hardeners, as in particular based on epoxy resins (synthetic mortar component di-functional and or multifunctional epoxy, hardener component di-functional and/or poly-functional organic amino and/or mercapto compounds), polyurethanes or polyureas or mixtures thereof (synthetic mortar component di-isocyanates and/or polyisocyanates, optionally also in the form of prepolymers, hardener component two or more hydroxyl, amino or hydroxyl and/or amino group-carrying organic compounds or mixtures thereof), alkoxy-silane terminated prepolymers (synthetic mortar component alkoxy silane terminated prepolymer, hardener component water and/or organic or inorganic acid(s)), or those based on reactive olefins as the synthetic mortar component (complementary hardener component in each case radically curing hardener), e.g. based on (meth)acrylic esters or amides, this term including in particular the esters and/or amides of acrylic acid and/or methacrylic acid ((meth)acrylic always stands for acrylic and/or methacrylic), such as mono-, di-, tri- or poly(meth)acrylates, (especially vinyl esters, such as epoxy (meth)acrylate, urethane (meth)acrylate, urea (meth)acrylate, urethane/urea (meth)acrylate, ethoxylated bisphenol A di(meth)acrylate or the like, and optionally reactive diluents, such as e.g. alkyl (meth)acrylate, hydroxyalkyl (meth)acrylate and/or alkyl (meth)acrylate, such as hydroxypropyl (meth)acrylate, hydroxyethyl (meth)acrylate, ethylene glycol di(meth)acrylate or butanediol (meth)acrylate);

wherein also mixtures of two or more such systems can be considered and wherein the variants given in parentheses are in each case examples of possible embodiments.

Especially preferred are radically curing systems based on synthetic mortars including vinyl groups, and radically curing hardeners, in particular vinyl ester resins (synthetic mortar component alkyl diacrylate with or without hydroxyl(meth)alkyl acrylate and/or macro-monomers with two acrylic and/or methacrylic end groups, hardener component radically curing hardener) or other radically curable resins as mentioned above. The associated reactive constituents of the synthetic mortar component (monomers, prepolymers and/or macro-monomers) may, based on the total volume of the synthetic mortar component, be present, for example, in a proportion of from 5 to 100, e.g. from 10 to 60% by weight.

Reactive diluents, as already defined above, may be provided in the synthetic mortar component or components, or different or further reactive diluents, e.g. for radically curing systems for example styrene, divinyl benzene, p-n-alkyl styrene, such as α-methyl styrene, vinyl toluene or tert-butyl styrene; the reactive diluents may, based on the total volume of the complete reactive synthetic resin, be provided for example in an amount of from 0 to 80% by weight, e.g. from 1 to 50% by weight.

In the case of radically curing systems, the hardener component includes one or more initiators or for other systems those as mentioned above. Customary initiators or stabilised hardeners with or without an addition of filler and/or solvent are used as initiator(s) in the hardener component in the case of radically curing systems. The amount of the total hardener component, based on the volume of the hardener component, is for example in the range from 0.1 to 100, in a possible preferred variant from 5 to 50% by weight. Possible hardeners, especially anionic, cationic or above all radical initiators are mentioned for example in DE 101 15 587, which in this regard is incorporated herein by reference. A possible example is dibenzoyl peroxide.

Alongside, there may be added, e.g. customary accelerators, e.g. aminic accelerators, inhibitors (especially in the synthetic mortar, but alternatively or additionally also in the hardener component), e.g. phenothiazine, hydroxylated benzenes, such as phenols or hydroquinones, phosphite, methylene blue or n-oxide radical derivatives, or the like, or mixtures of two or more thereof, in customary amounts, for example in a weight proportion of altogether 0.0001 to 10% by weight, based on the total weight of the reactive synthetic resin.

Multi-component synthetic resin systems according to the invention may, in one or more of their components, include one or more further additives. Further additives which may be included are plasticisers, non-reactive diluents or flexibilisers, e.g. solvents, stabilisers (e.g. HALS), curing catalysts, rheology aids, thixotropic agents, control agents for the reaction rate, e.g. inhibitors or accelerators or catalysts, wetting agents, colouring additives, such as dyes or especially pigments, for example, for staining the components different colours for improved monitoring of their mixing or to achieve specific colourations in the case of the coatings obtainable following use according to the invention, dispersants, emulsifiers, antioxidants, light stabilisers, UV or IR stabilisers, flame retardants, adhesion promoters, levelling agents, or in particular foam stabilisers (for example, based on silicon or in particular on a silicon-free basis), or other additives or the like, or mixtures of two or more thereof. Such further additives can be present preferably collectively, based on the total weight of the reactive synthetic resin, in total weight proportions of from 0 to 50% by weight, for example, from 0.01 to 10% by weight.

Fillers may also be present in one or more components. As fillers there may be used, if desired, customary fillers, in particular chalks, quartz powder, sand, polymer powders or the like, which can be added as a powder, in granular form or in the form of moulded bodies, or others, as named for example in WO 02/079341 and WO 02/079293 (which in this regard is incorporated herein by reference), or mixtures thereof. The fillers may be provided in one or more components of a multi-component synthetic resin system according to the invention. The proportion of filler(s) may be, for example, 0 (or e.g. 0.1) to 80% by weight, based on the total weight of the reactive synthetic resin.

The weight ratio of reactive mortar to hardener component (reactive mortar: hardener component) is, for example, in the range from 1:3 to 50:1, e.g. 1:1 to 10:1.

In a possible preferred embodiment, crosslinking multi-component reactive synthetic resin systems are used, that is, those that react to give thermoset materials.

Preferably a synthetic resin system according to the invention (or to be used or prepared in accordance with the invention) can be provided in the form of a two-component or three-component kit (preferably a two-component kit having components (a) and (b)), in particular in the form of a two-chamber or also multi-chamber device, which holds the components (a) and (b) capable of reacting react with one another in such a manner that during storage they are unable to react with each other, preferably in such a manner that before use they do not come into contact with each other. Especially suitable are foil pouches having two or more compartments, or containers such as buckets or tubs having several compartments, or sets (e.g. packages) of two or more such containers, wherein two or more components of the particular curable composition, in particular two components (a) and (b) as defined above and below, are each present, separated spatially from one another, in the form of a kit or set, in which the content after mixing or during mixing is introduced with customary auxiliaries into the application site (especially a recess, such as a drill hole), in particular for securing fixing means, such as anchoring means, e.g. anchor rods or the like; and also preferably multi-component or in particular two-component cartridges, in the chambers of which, for storage prior to use, are contained the several or preferably two components (in particular (a) and (b)) for a curable compound for fixing purposes with compositions mentioned above and hereafter, wherein preferably also a static mixer is part of the corresponding kit, which permits mixing by extrusion directly into a recess, such as a drill hole. In cases where foil pouches and multi-component cartridges are used, an emptying device can form part of the multi-component kit, but this may preferably also (for example, for multiple use) be independent of the kit.

Finely distributed means that the size of gas bubbles is preferably 1 mm or less, preferably 0.1 mm or less, and in an especially preferred embodiment the gas, or in the case of gas mixtures (in particular air), the gases or proportions thereof, are present, that is, in particular dissolved and/or dispersed, in atomic form (in the case of noble gases), in molecular form and/or in the form of micro-disperse gas bubbles in at least one of the components of the synthetic resin. These details apply in particular to the packaged form after a certain rest period, after which the volume may have changed slightly to close to or into a state of equilibrium owing to expansion of the gas or gases.

In the expanded form of the component(s), the volume proportion of the gas or gas mixture, e.g. of air, based on the total volume of all components of the multi-component synthetic resin system, is preferably in the range from 1 or 20% by volume, e.g. in the range from 2 to 15% by volume, for example, in the range from 4 to 10% by volume. At the same time, (to ensure comparable compressibility), the gas or gas mixture may be provided in all components, preferably in each case in approximately the same volume percent proportion (e.g. differing by at most ±10 relative percent from each other).

“Components” are understood above and hereafter to mean only the materials or mixtures present in containers or chambers, not the packaging, such as cartridges, pouches or the like.

The invention relates in a preferred embodiment to a multi-component synthetic resin system (for example in the form of a two-component kit) in ready-to-use packaged form, and also to individual, pre-packed components with finely distributed gas or finely distributed gases, which can be employed for or in particular are adapted to the use according to the invention.

The use of a multi-component synthetic resin system according to the invention for securing fixing elements occurs primarily in the construction industry, in particular in the fixing of fixing elements, in particular anchoring elements, such as e.g. threaded rods, of metal (alloys inclusive) or a different material, in solid substrates, such as plates, pillars, floors, steps, walls, ceilings, pavings or the like, (e.g. of concrete, natural stone, masonry of solid bricks or perforated bricks, asphalt, furthermore plastics material or timber), in particular in recesses, such as holes, primarily drill holes. In the case of the use according to the invention, a multi-component synthetic resin system according to the invention is used, which means in particular that its components are mixed just before or during use (by means of a static mixer when using multi-chamber cartridges for example) and are subsequently or simultaneously introduced into recess, in particular a drill hole, at least one fixing element being likewise simultaneously or subsequently introduced, for example by hammering and/or rotating. Through the reactions of the reactive constituents, hardening to a solid mass ensues at the same time and subsequently, giving the fixing element support.

Measurement of properties of the fixing compounds and the resulting effects, e.g. in respect of density, pull-out force, tensile strength, extrusion force and stability, can generally be effected according to the methods described in the examples (also for compositions other than those named therein).

In this connection, one can observe, for example, decreases in the density of the synthetic mortar component and/or hardener component, e.g. in the range from 1 to 20%, comparable pull-out forces required, e.g. in the range from 95 to 105% of those of degassed multi-component synthetic resin systems, a comparable tensile strength, e.g. in the range from 90 to 110% of that of degassed multi-component synthetic resin systems, a reduced extrusion force out of cartridges, e.g. in the range from 70 to below 100% of that of degassed multi-component synthetic resin systems, and/or an improved stability, without other relevant mechanical parameters being adversely affected.

The invention also relates to the use of one or more gases, in particular air, in finely distributed form for reducing the density of a multi-component synthetic resin, for reducing the required extrusion force (e.g. out of cartridges or foil pouches), for increasing the stability and/or for increasing the tensile strength, the air being introduced in finely distributed form into one or more components of the multi-component synthetic resin systems, for example as described in the method below.

The method according to the invention provides that (before or during filling) one or more gases, such as air, are finely distributed, in particular dissolved and/or dispersed, for example by beating, shearing action, stirring, blowing in, chemical generation and/or ultrasound, in one or more of the components (in the case of a two-component system for example the components (a) and/or (b) as described above) of a multi-component synthetic resin system.

The method can be carried out at elevated temperatures, at low temperatures and/or at room temperature, for example at temperatures in the range from −20 to 50° C.

The gas or gases or gas mixtures (such as air) can already be included wholly or partially in the component or components (for example in the form of macroscopically visible air bubbles) and/or it or they can be supplied during the method.

The method may be carried out e.g. at atmospheric pressure and/or at pressures above and/or below it.

All ranges and definitions listed by way of example, (for example after “e.g.”, “for example”, “as”, or the like), may, but need not, stand for preferred ranges or definitions. More general ranges and definitions may (in particular in the claims, but also in the description) be substituted independently of one another, alone or severally, by narrower ranges or definitions, which may in each case represent preferred variants of the invention.

“Comprising”, “comprise”, “including” or “include” each mean that in addition to the mentioned constituents yet other constituents may be contained, whereas “consists of” “composed of” and “contain(ing)” means that the constituents mentioned in connection therewith are listed definitively. If a constituent is “provided” or “present”, this means that the corresponding system has (includes) this constituent.

Above and hereafter specifications of proportion or content in percent mean in each case percent by weight, unless otherwise stated.

Especially preferred embodiments of the invention are specified in the main and in particular the subsidiary claims—the claims are therefore incorporated here by reference in the description and also in the examples.

The following example serves to illustrate the invention, without limiting its scope:

A commercial product FIS V 360 S, fischerwerke, Waldachtal, Germany, based on a preparation of methacrylates and mineral fillers (Item No. 94404, Fischerwerke, Denzlingen, Germany), is compared with the same product in which the density was lowered in the mortar and hardener by stirring in air with a dissolver (air content about 5% by volume). In table 1, the resulting properties of the two systems are contrasted.

TABLE 1
Properties of the synthetic resin systems with/without air bubbles
(especially positive properties highlighted by underlining):

| Property | Without air bubbles | With air bubbles |
|---|---|---|
| Mortar density [g/cm³] | 1.75 | 1.66 |
| Hardener density [g/cm³] | 1.62 | 1.54 |
| Pull-out force¹ [kN] | 75 | 75 |
| M12 Bolt, 95 mm | | |
| Tensile strength² [Mpa] | 7.8 | 8.2 |
| Extrusion force³ [kN] | 0.8 | 0.7 |
| Stability⁴ | good | Very good |

Description of the measuring methods (please specify briefly in a reproducible manner):

¹⁾ To test the bond between fixing element and cured synthetic resin system, the particular two-component synthetic resin system is introduced by means of a two-chamber cartridge with static mixer into a well-cleaned drill hole of dimensions 14 mm (diameter)×95 mm (drilled depth), which has been drilled in concrete. A M12 bolt is pushed into the synthetic resin composition (embedment depth 95 mm). After the curing time (45 min at 20° C.), the failure load was determined by a pull-out test with close support. The test is effected by means of a tripod with hydraulic cylinder and load cell at a speed adjusted so that fracture occurs after about 5 to 30 sec.
²⁾ The tensile strength is determined in accordance with DIN EN ISO 527-I.
³⁾ The extrusion force is determined by moving the piston of a two-chamber cartridge equipped with a suitable static mixer forwards at a feed speed of 100 mm/min using two push rods and the force required for this is measured using a load cell.
⁴⁾ The stability is determined by subjective assessment, by discharging the reactive synthetic resin mixture from a cartridge using a static mixer onto a vertical surface and creep, running and/or dripping of the mixture is observed.

1. A multi-component synthetic resin system, characterised in that at least one of its components includes one or more finely distributed gases.

2. A multi-component synthetic resin system according to claim 1, characterised in that the gas or gases are distributed atomically, molecularly and/or micro-dispersely.

3. A multi-component synthetic resin system according to claim 1, characterised in that the gases are a gas mixture, in particular air.

4. A multi-component synthetic resin system according to claim 1, characterised in that it is a two-component system.

5. A multi-component synthetic resin system according to claim 1, characterised in that it includes a synthetic mortar component based on epoxy resin, polyurethane or polyurea or mixtures thereof, alkoxy-silane terminated prepolymers or in particular based on reactive olefins as the synthetic mortar component, e.g. based on (meth)acrylic esters or amides, this term including in particular the esters and/or amides of acrylic acid and/or methacrylic acid, such as mono-, di-, tri- or polyacrylates or preferably vinyl ester resins, such as epoxy acrylate, urethane acrylate, urea acrylate, urethane/urea acrylate or ethoxylated bisphenol A di(meth)acrylate; or other radically curable resins; or mixtures of two or more of these materials; and a hardener component.

6. A multi-component synthetic resin system according to claim 1, characterised in that it includes in at least one of the components at least one mineral material stabilisable by solution and/or hydration, in particular cement, gypsum, magnesia binders, phosphate binders, water glass or silicate concrete.

7. A multi-component synthetic resin system according to claim 1, characterised in that it includes a reactive diluent in the synthetic resin component or components.

8. A multi-component synthetic resin system according to claim 1, characterised in that it includes further additives in a proportion of in total 0 to 50% by weight in one or more of its components.

9. A multi-component synthetic resin system according to claim 1, characterised in that it is packaged in the form of a multi-component, in particular two-component kit, preferably in the form of a two-chamber cartridge.

10. A multi-component synthetic resin system according to claim 1, characterised in that the gas or gases is or are present in the form of gas bubbles having a diameter of 1 mm or less, in particular having a diameter of 0.1 mm or less.

11. A multi-component synthetic resin system according to claim 1 in a form packaged ready for use.

12. A multi-component synthetic resin system according to claim 1, characterised in that the volume proportion of the gas or gas mixture based on the total volume of all components of the synthetic resin system is in the range from 1 to 20% by volume, preferably from 2 to 15% by volume, in particular in the range from 3 to 15% by volume or from 4 to 10% by volume.

13. A multi-component synthetic resin system according to claim 1, characterised in that the gas or gas mixture is present in all components, preferably in each case in approximately the same volume % proportion.

14. A use of a multi-component synthetic resin system for fixing one or more fixing elements in a substrate, wherein a multi-component synthetic resin system according to claim 1 is used, which in at least one of its components includes one or more finely distributed (preferably atomically, molecularly and/or micro-dispersely distributed) gases, in particular air.

15. A use according to claim 14, wherein the use of the multi-component synthetic resin system in the construction industry, in particular for the fixing of fixing means, primarily anchoring means, is carried out in recesses, preferably drill holes.

16. A method for the preparation of a multi-component synthetic resin system, in particular according to claim 1, characterised in that one or more gases, such as air, are finely distributed in at least one of the components of the synthetic resin system.

17. A method according to claim 16, characterised in that the gas or gases are in each case finely distributed in the component or components, in particular dissolved and/or dispersed, preferably by beating, shearing action, stirring, blowing in, chemical generation and/or ultrasound, preferably before or during packaging of the components.
